(19) United States
(12) Patent Application Publication
(10) Pub. No.: US 2004/0144960 A1
(43) Pub. Date: Jul. 29, 2004

(54) Resin-magnet composition

(76) Inventors: Toshiaki Arai, Tokyo (JP); Masami Kikuchi, Tokyo (JP)

Correspondence Address: Sughrue Mion Zinn, Macpeak & Seas, 2100 Pennsylvania Avenue NW, Washington, DC, 20037, US

(21) Appl. No.: 10/475,992

(22) PCT Filed: Sep. 5, 2002
(86) PCT No.: PCT/JP02/09067

(30) Foreign Application Priority Data
Sep. 11, 2001 (JP) 2001-274636

(51) Int. Cl. H01B 1/00

(52) U.S. Cl. 252/500

(57) ABSTRACT

The fluidity at the time of molding of a resin magnet composition is improved by mixing an additive which contains at least one deterioration inhibitor comprising both a metal deactivator and a radical scavenger and at least one substituted urea-based lubricant with a resin magnet composition prepared by mixing and dispersing a rare earth magnetic alloy powder into a thermoplastic resin binder.

### BACKGROUND OF THE INVENTION

1 . Field of the Invention

The present invention relates to a resin magnet composition and, particularly, to a resin magnet composition which is used for injection molding and prepared by mixing and dispersing a rare earth magnetic alloy powder into a thermoplastic resin binder.

1 . Description of the Prior Art

Heretofore, as a permanent magnet for use in motors and electromagnetic relays for OA equipment, home electric appliances, production lines and mobile equipment, there has been known a bond magnet produced by mixing and dispersing a magnetic fine powder of a ferrite- or rare earth-based sintered magnet into a binder composed of a thermoplastic resin such as nylon, polyethylene or EVA, or a thermosetting resin such as epoxy resin or phenolic resin, forming the obtained kneaded product into a desired shape by pressure molding such as injection molding, compression molding or extrusion molding using a metal mold, and magnetizing the obtained molded product. Since this bond magnet can be treated like rubber or plastic due to high flexibility and has excellent workability, it is widely used in various fields as a permanent magnet for use in motors and electromagnetic relays and a magnet roller for use in developing rollers for copiers and printers.

Since the above bond magnet generally contains 5 to 15 wt % of a binder, its energy product (BH)ₘₐₓ is relatively low as compared with a sintered magnet. Therefore, in bond magnets used in products which need to be thin and small in size and have high magnetic force, such as a magnet for small-sized motors, rare earth magnetic alloy powders having high saturation magnetic flux density such as SmCo and NdFeB are used as the above magnetic powder.

In the method of molding the above bond magnet, injection molding is widely used because it has great mold design freedom and can form molded products which are various in shape.

As for the above injection molding, a pellet of a resin magnet composition prepared by mixing a magnetic powder for a bond magnet with a thermoplastic resin binder is introduced into a heating cylinder equipped with a heater and a screw to be heated, kneaded and fluidized in order to be plasticized, and the plasticized resin magnet composition is pressure fed into a metal mold having a cavity with a desired form from an injection cylinder and solidified by cooling to obtain a bond magnet molded into the form of the above cavity.

Since the plasticized resin magnet composition is pressure fed and charged into the cavity in the above injection molding, the above resin magnet composition must have fluidity in some measure.

However, when the magnetic powder is a rare earth magnetic alloy powder, the fluidity of the resin magnet composition in the cavity becomes unsatisfactory, whereby magnetic force lowers or surface magnetic force varies and also the mold may not be completely packed with the resin magnet composition with the result of a short shot, thereby causing a molding failure.

It is an object of the present invention which has been made in view of the above problems of the prior art to provide a resin magnet composition having high fluidity which is prepared by mixing and dispersing a rare earth magnetic alloy powder into a thermoplastic resin binder and is suitably used for injection molding.

### SUMMARY OF THE INVENTION

The present inventor has found that a deterioration inhibitor containing both a metal deactivator and a radical scavenger and a substituted urea-based lubricant which is a solid lubricant composed of a compound having an urea bond greatly contribute to the improvement of the melt fluidity of a resin magnet composition, out of additives such as a plasticizer, surface treating agent, deterioration inhibitor and solid lubricant which are added to a resin magnet composition prepared by mixing and dispersing a rare earth magnetic alloy powder into a thermoplastic resin binder used for injection molding. The present invention has been accomplished based on this finding.

That is, according to a first aspect of the present invention, there is provided a resin magnet composition prepared by mixing an additive which contains at least one deterioration inhibitor comprising both a metal deactivator and a radical scavenger with a resin magnet composition prepared by mixing and dispersing a rare earth magnetic alloy powder into a thermoplastic resin binder. A torque-up at the time of kneading can be suppressed and fluidity at the time of molding can be improved by the multiplication effect of the above metal deactivator and radical scavenger, thereby making it possible to obtain a rare earth bond magnet having high magnetic force.

According to a second aspect of the present invention, there is provided a resin magnet composition prepared by mixing an additive which contains at least one deterioration inhibitor having both a metal deactivating structure and a radical scavenging structure in the molecule with a resin magnet composition prepared by mixing and dispersing a rare earth magnetic alloy powder into a thermoplastic resin binder.

According to a third aspect of the present invention, there is provided a resin magnet composition, wherein the amount of the deterioration inhibitor is 0.01 to 5 wt % based on the total weight of the resin binder and the rare earth magnetic alloy powder.

According to a fourth aspect of the present invention, there is provided a resin magnet composition prepared by mixing an additive which contains at least one substituted urea-based lubricant composed of a substituted urea compound having a long-chain alkyl group, saturated aliphatic hydrocarbon group, unsaturated aliphatic hydrocarbon group or aromatic group substituted for one or two hydrogen atoms of urea with a resin magnet composition prepared by mixing and dispersing a rare earth magnetic alloy powder into a thermoplastic resin binder. Thereby, fluidity at the time of molding can be improved and a rare earth bond magnet having high magnetic force can be obtained.

According to a fifth aspect of the present invention, there is provided a resin magnet composition of claim 4, wherein the amount of the substituted urea-based lubricant is 0.01 to 5 wt % based on the total weight of the resin binder and the rare earth magnetic alloy powder.

According to a sixth aspect of the present invention, there is provided a resin magnet composition prepared by mixing an additive which contains at least one deterioration inhibitor comprising both a metal deactivator and a radical scavenger and at least one substituted urea-based lubricant with a resin magnet composition prepared by mixing and dispersing a rare earth magnetic alloy powder into a thermoplastic resin binder.

### BRIEF DESCRIPTION OF THE DRAWINGS

FIG. 1 is a table showing additives added in Examples of the present invention; and

FIG. 2 is a graph showing the measurement results of fluidity in Examples of the present invention.

### DETAILED DESCRIPTION OF THE PREFERRED EMBODIMENT

A preferred embodiment of the present invention will be described hereinbelow.

A kneaded product (resin magnet composition) is first prepared by mixing a rare earth magnetic alloy powder and an additive containing at least one deterioration inhibitor which comprises both a metal deactivator and a radical scavenger and at least one substituted urea-based lubricant with a thermoplastic resin binder and by kneading them together by means of kneading means such as a kneading extruder. Thereafter, the above kneaded product is cut or ground to obtain a pellet-like resin magnet composition which is then introduced into a heating cylinder from the hopper of an injection molding machine and injected into a mold having a cavity with a predetermined form through an injection nozzle to mold the above resin magnet composition.

The metal deactivator used in this embodiment preferably contains nitrogen in the structure. Examples of the metal deactivator include benzotriazole derivatives, imidazole derivatives, hydrazine derivatives, salicylate derivatives and oxalate derivatives such as 3-(N-salicyloyl)amino-1,2,4-triazole, disalicyloylhydrazide decamethylenedicarboxylate, oxalylbis[benzylidenehydrazide], 2′,3-bis[[3-[3,5-di-tert-butyl-4-hydroxyphenyl]propionyl]]propionohydrazide, bis(2-phenyoxypropionylhydrazide)isophthalate and 2,2′-oxalyldiamidebis[ethyl-3-(3,5-di-tert-butyl-4-hydroxypheny)propionate. Out of these, oxalate derivatives and hydrazide derivatives such as 2′,3-bis[[3-[3,5-di-tert-butyl-4-hydroxyphenyl]propionyl]]propionohydrazide, oxalylbis[benzylidenehydrazide] and bis(2-phenoxypropionylhydrzide)isophthalate are particularly preferred.

The radical scavenger is preferably a phenolic derivative. Examples of the radical scavenger include 2,6-di-o-butyl-4-methylphenol, n-octadecyl-3-(3′,5′-di-t-butyl-4′-hydroxyphenyl)propionate, 4,4-butylidenebis(3-methyl-6-t-buty)phenol, pentaerythritol tetrabis[3-(3,5-di-tert-butyl-4-hydroxyphenyl)propionate], N,N′-hexane-1,6-diylbis[3-(3,5-di-tert-butyl-4-hydroxyphenylpropionamide)], ethylenebis(oxyethylene)bis[3-(3,5-di-tert-butyl-4-hydroxy-m-tolyl)propionate], hexamethylenebis[3-(5-tert-butyl-4-hydroxypheny)propionate], 1,1,3-tris(2-methyl-4-hydroxy-5-tert-butylphenyl)butane, triethylene glycol bis[3-(3-tert-butyl-4-hydroxy-5-methylphenyl)propionate] and 2′,3-bis[[3-[3,5-di-tert-butyl-4-hydroxyphenyl]propionyl]]propionohydrazide. Out of these, 2′,3-bis[[3-[3,5-di-tert-butyl-4-hydroxypheny]propionyl]]propionodhydrazide, ethylenebis(oxyethylene)bis[3-(3,5-di-tert-butyl-4-hydroxy-m-toly)propionate], N,N′-hexane-1,6-diylbis[3-(3,5-di-tert-butyl-4-hydroxyphenylpropionamide)] and triethylene glycol bis[3-(3-tert-butyl-4-hydroxy-5-methylphenyl)propionate] are particularly preferred.

Since the resin magnet composition of the present invention is mixed with an additive containing at least one deterioration inhibitor which comprises both a metal deactivator and a radical scavenger, a torque-up at the time of kneading can be suppressed and fluidity at the time of molding can be improved by the multiplication effect of the above metal deactivator and radical scavenger, thereby making it possible to obtain a rare earth bond magnet having high magnetic force.

To obtain the above effect, both a metal deactivator and a radical scavenger must be contained in the resin magnet composition. When only a metal deactivator or a radical scavenger is added, fluidity rarely improves.

Since 2′,3-bis[[3-[3,5-di-tert-butyl-4-hydroxphenyl]propionyl]]propionohydrazide out of the above examples is a deterioration inhibitor which has a metal deactivating structure and a radical scavenging structure in the molecule, even when it is added alone, fluidity at the time of molding can be improved.

The substituted urea-based lubricant used in this embodiment is a solid lubricant composed of a substituted urea compound having a long-chain alkyl group, saturated aliphatic hydrocarbon group, unsaturated aliphatic hydrocarbon group or aromatic group substituted for one or two hydrogen atoms of urea, particularly preferably a substituted urea compound having no (—NH₂) structure in urea after substitution. Examples of the above saturated aliphatic hydrocarbon group include lauryl group, stearyl group and palmityl group, examples of the above unsaturated aliphatic hydrocarbon group include oleyl group and erucallyl group, and examples of the aromatic group include phenylmethane group and xylyl group.

Illustrative examples of the substituted urea-based lubricant include diphenylmethane bislaurylurea, diphenylmethane bisstearylurea, hexamethylene bisstearylurea, toluylene bisstearylurea, xylene bisstearylurea, N-butyl-N′-stearylurea, N-phenyl-N′-stearylurea and N-stearyl-N′-stearylurea. Out of these, diphenylmethane bislaurylurea, diphenylmethane bisstearylurea, hexamethylene bisstearylurea, toluylene bisstearylurea and xylene bisstearylurea are particularly preferred.

The amount of the above substituted urea-based lubricant which is suitably determined according to the types of the magnetic powder and binder resin is generally 0.01 to 5 wt %, preferably 0.02 to 2 wt %.

Since the above substituted urea-based lubricant contributes to the effect of suppressing a torque-up at the time of kneading and the effect of improving fluidity at the time of molding like the above-described deterioration inhibitor which comprises both a metal deactivator and a radical scavenger, it can further enhance the above effects.

It is not necessary to add both the deterioration inhibitor and the substituted urea-based lubricant. When one of them is added, it can fully suppress a torque-up at the time of kneading and improve fluidity at the time of molding.

A monoester having no branched structure may be added together with the above deterioration inhibitor and substituted urea-based lubricant.

Examples of the thermoplastic resin used in this embodiment include polyamide resins (PA), polystyrene resins, polyethylene terephthalate resins (PET), polybutylene terephthalate resins (PBT), polyphenylene sulfide resins (PPS), ethylene-vinyl acetate copolymer resins (EVA) and ethylene-ethyl acrylate copolymer resins (EEA). They may be used alone or in combination of two or more. In the present invention, polyamide resins such as polyamide-6, polyamide-12, polyamide-66, polyamide-11 and polyamide-46 are preferred, and polyamide-12 and polyamide-6 are particularly preferred.

Examples of the rare earth magnetic powder to be mixed with and dispersed into the above resin binder include Nd-based magnetic powders such as Nd₂F₁₄B, and Sm-based magnetic powders such as Sm₂Fe₁₇N₃. These magnetic powders may be used alone or in combination of two or more. The above magnetic powder is used as a powder and is not limited by its particle diameter. However, from the viewpoints of the melt fluidity of the obtained resin magnet composition, the alignment of the magnetic powder and packing, the average particle diameter of the magnetic powder is 1 to 250 μm, particularly preferably 20 to 50 μm.

The rare earth magnetic powder may be subjected to a known pre-treatment in order to improve its adhesion to the binder. For example, when it is treated with a known coupling agent such as a silane-based or titanium-based coupling agent, melt fluidity at the time of high loadings can be improved.

The ratio of the resin binder and the magnetic powder to the resin magnet composition is not particularly limited and is suitably selected according to magnetic force required for the resin molded product. In general, the magnetic powder is used in an amount of 70 to 95 wt % based on the weight of the resin magnet composition.

To the above resin magnet composition may be added a filler having a large reinforcing effect such as mica, talc, fiber exemplified by carbon fiber and glass fiber, and whisker in limits that do not impair the object of the present invention. That is, when magnetic force required for a molded article is relatively small and the amount of the magnetic powder is small, the stiffness of the obtained molded article is apt to be low. In this case, to increase the stiffness, a filler such as mica or whisker may be added to reinforce the molded article. Mica and whisker are preferably used as a filler in this case. Examples of the whisker include non-oxide-based whiskers such as silicon carbide and silicon nitride, metal oxide-based whiskers such as ZnO, MgO, TiO₂, SnO₂ and Al₂0₃, and composite oxide-based whiskers such as potassium titanate, aluminum borate and basic magnesium sulfate. Out of these, composite oxide-based whiskers are preferred because it is easy to compound a plastic with them.

Although the method of preparing the above resin magnet composition is not particularly limited, a resin binder, a magnetic powder and optionally a filler are mixed and melt kneaded together in accordance with a commonly used method and molded into a pellet to prepare a resin magnet composition. For melt kneading, a commonly used method using a single-screw or double-screw kneading extruder, or KCK kneading extruder and common used conditions may be employed.

### EXAMPLES

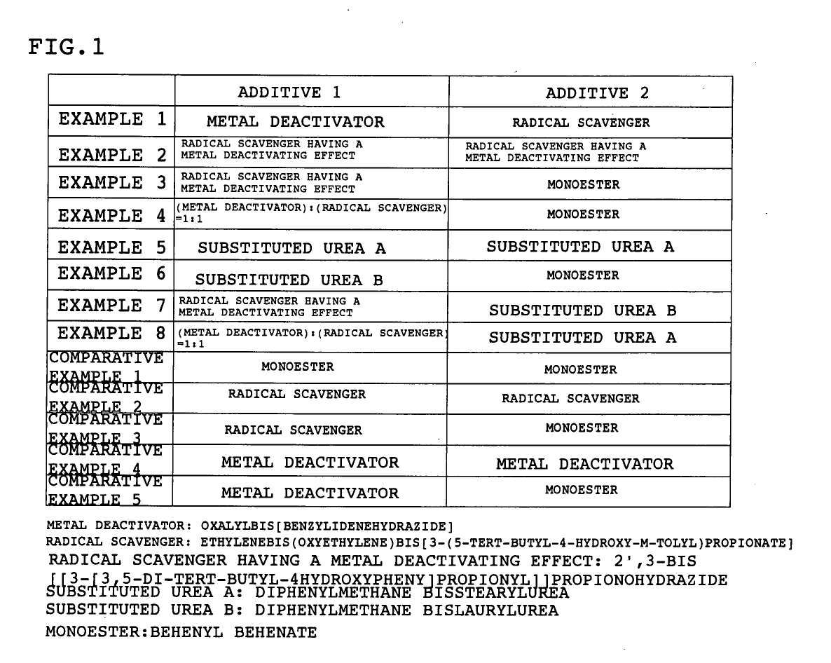

The following examples and comparative examples are provided for the purpose of further illustrating the present invention but are in no way to be taken as limiting. 2,000 g of a magnetic powder obtained by grinding an Nd-based rare earth magnetic alloy raw material (MQP-B of MQI Co., Ltd.) composed of Nd₁₂Fe₇₈Co₄B₆ in terms of atomic wt % to an average particle diameter of 50 μm and classification was weighed, 120 g of nylon 12 having an Mw of about 12,000 (P3012U of Ube Kosan Industries, Ltd.), 10 g of additive 1 and 10 g of additive 2 each of which is composed of one of a metal deactivator, radical scavenger and substituted urea-based lubricant shown in the table of FIG. 1 or a mixture thereof were mixed together to prepare resin magnet compositions. Thereafter, the obtained mixtures were kneaded by a laboratory plastomill manufactured by Toyo Seiki Co., Ltd. and milled by a hammer mill to prepare particulate resin magnet compositions containing a deterioration inhibitor which comprised both a metal deactivator and a radical scavenger or a substituted urea-based lubricant and particulate resin magnet compositions which contained both the above deterioration inhibitor and substituted urea-based lubricant (Examples 1 to 8). As Comparative Examples 1 to 5, resin magnet compositions which contained only one of a metal deactivator and a radical scavenger and resin magnet compositions which contained none of them were prepared in the same manner as in the above Examples. In Examples, the treatment of the surface of the magnetic powder which is generally carried out was omitted to confirm the effects of the additives.

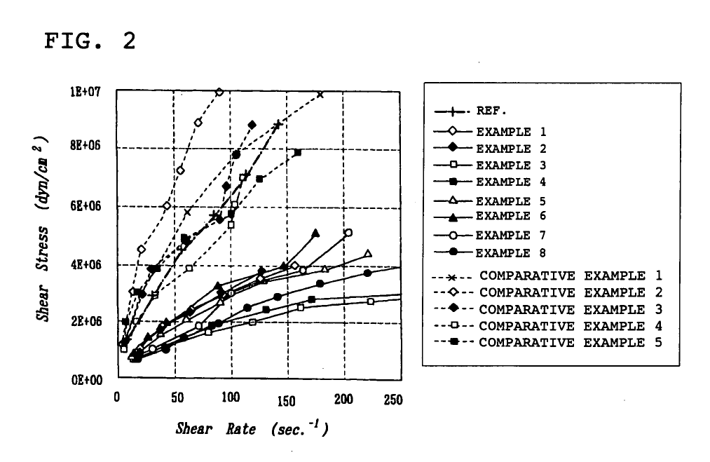

The fluidity of each sample was then measured using the Flowtester of Shimadzu Corporation. As for measurement conditions, each sample was measured at 240° C. with a dice having a diameter of 1 mm and a length of 5 mm. The measurement results are shown in the graph of FIG. 2. In the figure, shear rate is plotted on the horizontal axis and shear stress is plotted on the vertical axis. When the shear rate was the same, as the shear stress decreased, flow resistance became lower, that is, fluidity became higher. The sample (ref.) marked with a symbol (+) shown by a one-dot chain line did not contain any additive (Reference Example).

As obvious from the graph, the samples of Examples 1 to 8 had low shear force and greatly improved fluidity as compared with the samples of Comparative Examples 1 to 5.

Each of the above samples was injection molded at a cylinder temperature of 270° C., a mold temperature of 150° C. and an injection pressure of 100 kg/cm² by the injection molding machine of FANUC to form a rectangular parallelepiped resin magnet molded product measuring 10 mm×4 mm×100 mm.

The resin magnet molded products obtained from the samples of Examples 1 to 8 were satisfactory in terms of appearance, dimensional accuracy and variation in surface magnetic force whereas resin magnet molded products obtained from the samples of Comparative Examples 1 to 5 had molding troubles such as a short shot and resin packing failure.

It was thereby confirmed that the resin magnet composition of the present invention had greatly improved fluidity at the time of molding as well.

### Industrial Feasibility

As described above, according to the present invention, the fluidity at the time of molding of a resin magnet composition can be improved by mixing an additive which contains at least one of a deterioration inhibitor comprising both a metal deactivator and a radical scavenger and a substituted urea-based lubricant with a resin magnet composition prepared by mixing and dispersing a rare earth magnetic alloy powder into a thermoplastic resin binder. Therefore, a rare earth bond magnet having high magnetic force and little variation in surface magnetic force can be obtained by injection molding the above resin magnet composition.

What is claimed is:

1. A resin magnet composition prepared by mixing an additive which contains at least one deterioration inhibitor comprising both a metal deactivator and a radical scavenger with a resin magnet composition prepared by mixing and dispersing a rare earth magnetic alloy powder into a thermoplastic resin binder.

2. A resin magnet composition prepared by mixing an additive which contains at least one deterioration inhibitor having both a metal deactivating structure and a radical scavenging structure in the molecule with a resin magnet composition prepared by mixing and dispersing a rare earth magnetic alloy powder into a thermoplastic resin binder.

3. The resin magnet composition of claim 1 or 2, wherein the amount of the deterioration inhibitor is 0.01 to 5 wt % based on the total weight of the resin binder and the rare earth magnetic alloy powder.

4. A resin magnet composition prepared by mixing an additive which contains at least one substituted urea-based lubricant with a resin magnet composition prepared by mixing and dispersing a rare earth magnetic alloy powder into a thermoplastic resin binder.

5. The resin magnet composition of claim 4, wherein the amount of the substituted urea-based lubricant is 0.01 to 5 wt % based on the total weight of the resin binder and the rare earth magnetic alloy powder.

6. A resin magnet composition prepared by mixing an additive which contains at least one deterioration inhibitor comprising both a metal deactivator and a radical scavenger and at least one substituted urea-based lubricant with a resin magnet composition prepared by mixing and dispersing a rare earth magnetic alloy powder into a thermoplastic resin binder.
